(19) United States
(12) Patent Application Publication
(10) Pub. No.: US 2014/0244339 A1
(43) Pub. Date: Aug. 28, 2014

(54) ENTERPRISE CONTENT MANAGEMENT DEPLOYMENT, COLLABORATION, AND PROPOSAL TOOL

(71) Applicant: HYLAND SOFTWARE, INC., Westlake, OH (US)

(72) Inventors: Mark Davis, Avon Lake, OH (US); Michael D. Discenzo, Westlake, OH (US)

(73) Assignee: HYLAND SOFTWARE, INC., Westlake, OH (US)

(21) Appl. No.: 13/774,005

(22) Filed: Feb. 22, 2013

(51) Int. Cl. G06Q 10/06

(52) U.S. Cl. CPC G06Q 10/06315
USPC 705/7.25

(57) ABSTRACT

A method executed by a processor of a computing device provides enterprise content management (ECM) solution information. A set of ECM solutions is accessed from a data storage and transmitted through a network to an organization. Planning input comprising indications of selected ECM solutions is received through the network. Implementation information for implementing the indicated ECM solutions is determined based at least in part upon the planning input, and is transmitted to the organization through the network. When an organization is identified based on an ECM organization identifier, organization information associated with the identified organization is accessed from the data storage, and the planning data is modified based on the organization information. When implementing two or more ECM solutions together has a synergistic reduction in implementation requirements compared to implementing the solutions separately, the reduction is determined and included in the implementation information.

### FIELD

This disclosure relates to enterprise content management (ECM) systems and electronic methods for providing the same.

### BACKGROUND

Historically, software and technical consulting firms have relied on being the sole source of expertise and knowledge in a field, often relying on customer's unfamiliarity with technology and developments in the field. While this business model traditionally has been widely successful in the ECM field, today's customers are becoming more educated and technically savvy and are seeking options for investigating their own ECM implementation strategies. While an ECM provider's expert opinion on a particular project along with a cost quote is still valued, with a greater number of ECM customers being charged with making informed, lowest-dollar decisions, a greater number of organizations are mandating that appropriate research be completed prior to engaging an ECM provider. The expert opinion of an ECM provider is often no longer considered to be the end of the decision-making process.

Implementing an ECM solution can involve significant amounts of an organization's personnel for significant amounts of time. The involvement of management personnel, in-house IT professionals, and lower-level employees is often required in the implementation process. Implementation of an ECM solution may also require hardware resources such as servers or other computing hardware, and may require shutdowns of key databases and networks. Accordingly, reliance on a simple, undetailed proposal originating from the ECM provider may not provide an organization with enough information to effectively plan for the implementation. This can lead to delays that are costly for both the ECM provider and the organization. In addition, there may be unrealized synergistic improvements in efficiency that may result in an organization implementing certain combinations of ECM solutions together.

### SUMMARY

In an embodiment, a method executed by a processor of a computing device is described herein for providing ECM solution information. A set of ECM solutions is accessed from a data storage of the computing device of an ECM provider. ECM data, comprising the set of ECM solutions is transmitted through a network to an organization seeking ECM solution information.

Upon the organization selecting one or more ECM solutions from amongst the set of ECM solutions, planning input is transmitted through the network from the organization to the ECM provider. The planning input, comprising an indication of the one or more ECM solutions selected from amongst the set of ECM solutions, is received by the ECM provider through the network.

Responsive to receiving the planning input, planning data associated with the one or more indicated ECM solutions is accessed from the data storage. Implementation information is determined based at least in part upon the planning data, wherein the implementation information comprises at least one of a time period for implementing the one or more indicated ECM solutions, or a resource requirement for implementing the one of more indicated ECM solutions. The implementation information is transmitted through the network from the ECM provider to the organization.

In another embodiment, a method executed by a processor of a computing device is described herein for providing ECM solution information to an identified organization. An organization seeking ECM solution information transmits a request comprising ECM organization identifier input to an ECM provider through a network. The ECM organization identifier input is received through the network by the ECM provider. An identified organization is determined by identifying the organization based at least in part upon the ECM organization identifier input.

A set of ECM solutions and ECM organization information associated with the identified organization are accessed from a data storage of the computing device of the ECM provider. ECM data is transmitted through the network to the organization. Responsive to receiving planning input from the organization, planning data associated with one or more indicated ECM solutions is accessed from the data storage. The planning data is modified based at least in part upon the ECM organization information.

Implementation information is determined based at least in part upon the planning data and the ECM organization information, and is transmitted to the organization through the network.

In another embodiment, a method executed by a processor of a computing device is described herein for providing ECM solution information to an organization based at least in part upon synergism information. A set of ECM solutions is accessed from a data storage of the computing device of an ECM provider. The set of ECM solutions is transmitted to an organization through a network.

Upon the organization selecting two or more ECM solutions from amongst the set of ECM solutions, planning input is transmitted through the network from the organization to the ECM provider. The planning input, comprising an indication of the two or more ECM solutions selected from amongst the set of ECM solutions, is received by the ECM provider through the network.

Responsive to receiving the planning input, planning data and synergism information associated with the two or more indicated ECM solutions are accessed from the data storage. A reduction in the implementation requirements of the two or more ECM solutions when implemented together is determined based at least in part upon the planning data and synergism information. The reduction is at least one of a reduced total time period, reduced total cost, or reduced total resource requirement associated with implementation of the two or more indicated ECM solutions together, respectively compared to a sum of respective time periods, costs, or resource requirements associated with the implementation of each of the two or more indicated ECM solutions separately.

Implementation information comprising at least one of the reduced total time period, the reduced total resource requirement, or the reduced total cost is determined based at least in part upon the planning data and the synergism information, and is transmitted to the organization through the network.

The articles “a,” “an,” and “the” should be interpreted to mean “one or more” unless the context clearly indicates the contrary. The term “set” as used herein, should be interpreted to mean a set with at least one member, and not an empty set, unless the context clearly indicates the contrary. Additionally, as used herein, the term “exemplary” is intended to mean serving as an illustration or example of something, and is not intended to indicate a preference.

### BRIEF DESCRIPTION OF THE DRAWINGS

FIG. 1 is a flow diagram that illustrates an exemplary methodology for providing ECM solution information.

FIG. 2 is an image depicting an embodiment of a graphical user interface with ECM data.

FIG. 3 is an image depicting an embodiment of a graphical user interface with implementation information.

FIG. 4 is a flow diagram that illustrates another exemplary methodology for providing ECM solution information.

FIG. 5 is a flow diagram that illustrates yet another exemplary methodology for providing ECM solution information.

FIG. 6 is another image depicting an embodiment of a graphical user interface with ECM data.

FIG. 7 is a flow diagram that illustrates yet another exemplary methodology for providing ECM solution information.

FIG. 8 is an exemplary system for providing ECM solution information.

FIG. 9 is a schematic of an example computing device for use in the methods and systems described herein.

### DETAILED DESCRIPTION

Disclosed herein are methods and systems for a computer-implemented tool with which organizations can investigate different sets of enterprise content management (ECM) solutions, quickly receive cost, resource requirement, and time-to-implement information estimates and quotes, and construct a plan for implementing a set of ECM solutions that can be shared and collaborated on internally before being shared with an ECM provider. The tool also benefits the ECM provider by providing opportunities for further interaction with clients and further exposure of services they offer.

An ECM provider is an entity that provides for the planning and implementation of ECM solutions within an organization. Such providing can be through acting as a source of expertise, knowledge, tools and materials for implementing ECM solutions. Such solutions are often tailored to specific industry types or sub-types, and in some cases are specifically tailored to a particular organization. In some cases, ECM providers provide ongoing guidance, services, management and storage, in other cases an ECM provider provides for the implementation of the same within an organization, and yet other cases may be a combination thereof. The term “ECM organization” as used herein refers to an organization in need of, receiving, distributing or reselling ECM solutions.

ECM is the strategies, methods and tools used to capture, manage, store, preserve, and deliver content and documents related to an organization. “Organization,” as used herein, means a company, organization, business, non-profit, charitable, or other group conducting operations. ECM solutions allow the management of an organization's unstructured information. In an embodiment, ECM solutions or a portion thereof are computer implemented solutions with electronic, magnetic, or optically stored media.

ECM includes the following sub-categories: web content management, collaborative content management, and transactional content management.

Web content includes information or documents resident on internet or cloud-based servers. ECM in the web content management field includes management of websites and databases as well allowing several content producers the ability to create and publish content (articles, photo galleries and so forth). An ECM solution in this area allows for dynamic uploading and editing of content.

Collaborative content includes documents or other content that multiple users have or need access to. An ECM solution is enabled to be accessed and edited by multiple users simultaneously. For example, an entire team can work from the same master document, tracking changes, saving minor drafts and embedding files.

Transaction content includes a collection of physical documents that may be turned into electronically-, magnetically-, or optically-stored documents. For example, an organization may have a lot of physical documents, such as, insurance claims, medical records, government forms, payroll, student admissions, etc. An ECM solution in this area ideally provides an efficient way to maintain and access those documents and may provide automated and repeatable business processes and integration with other business applications.

ECM solutions, while beneficial to an organization once implemented, comprise costs, resource requirements, and time requirements in order to be implemented. Thus, examining these factors, and the benefit of the associated ECM solution is an important part of developing an ECM solution package, or a set of ECM solutions purchased as a set that may impact different areas of an organization and may be interrelated or synergistic.

Various exemplary methodologies are illustrated and described below. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be any suitable computer-readable storage device, such as memory, hard drive, CD, DVD, flash drive, or the like. As used herein, the term “computer-readable medium” is not intended to encompass a propagated signal.

Additionally, it should be understood that a step or steps may be subdivided into sub-steps, combined together in combined steps, or combinations thereof.

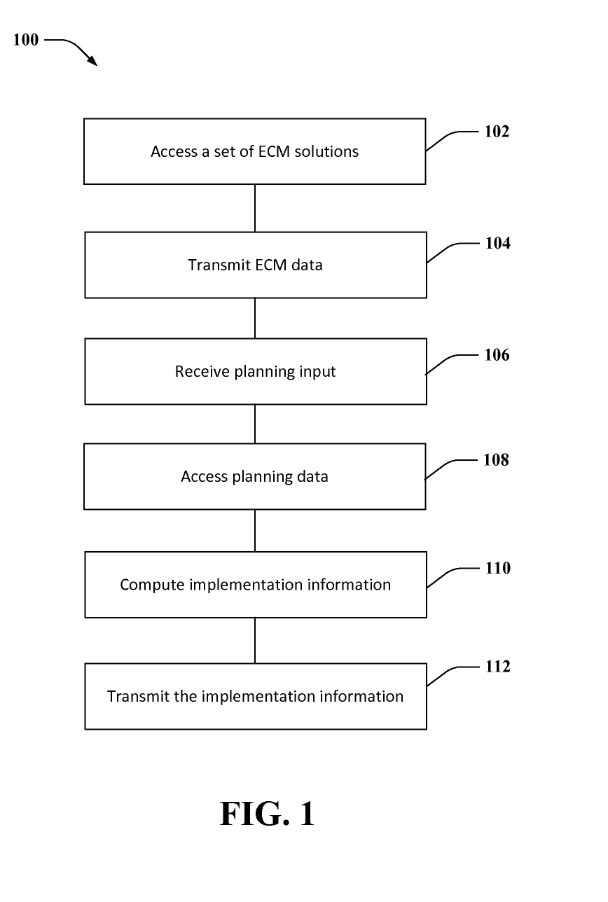

Referring now to FIG. 1, an exemplary methodology 100 that facilitates providing ECM solution information is illustrated. In this embodiment the methodology 100 facilitates the retrieval of information of special importance in the ECM field. It provides the requesting organization with not just a fixed or estimated cost for implementing a solution, but also with resource requirements and a time period or schedule for the implementation. ECM solution information is provided to an organization, which can then indicate selections of one or more ECM solutions. Implementation information relating to the selected ECM solutions is then transmitted to the organization.

The methodology 100 starts by accessing a set of ECM solutions at 102. In some embodiments, the access may be responsive to an organization's request for ECM solution information. For example, prior to step 102, the organization may have logged in to a remote web service, or otherwise transmitted a request to the ECM provider, the organization may have started client software on a computing device of the organization, or may have used such software to generate a request for ECM solution information. Such logging on or use of software may comprise authentication or privacy information such that subsequent communication between the ECM provider and the organization is encrypted or secured.

The set of ECM solutions may be stored in a data storage, such as a data repository or set of data repositories implemented as, for example, a MySQL database, or the like. In some embodiments, the data storage is a data storage of the ECM provider and may be in communication with, or in some embodiments is comprised by, a server, wherein the server may be configured to communicate with other devices, for example through a network such as, a LAN, WAN, or the Internet. For example, the server may be an APACHE web server. In other embodiments, the data storage is in communication with or is comprised by a computing device of an entity other than the ECM provider, such as, for example, a computing device of the organization or a computing device of a web host.

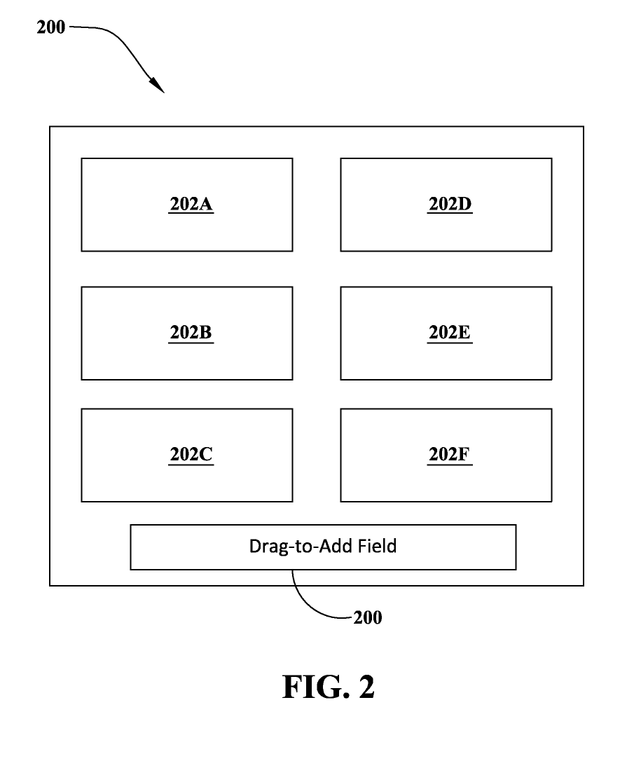

At 104, ECM data from the data storage that includes the set of ECM solutions is transmitted through the network. The ECM data may additionally comprise ECM solution detailed information as described below. The ECM data may be transmitted to a computing device, such as a computing device of the organization. In some embodiments, such a computing device comprises a display configured to display at least a portion of the ECM data. The ECM data comprises a GUI configured such that the display facilitates the selection of one or more ECM solutions. An exemplary embodiment of a GUI configured to be displayed by the ECM data is illustrated in FIG. 2 and is discussed below.

Planning input is received through the network at 106. The planning input comprises an indication of one or more selected ECM solutions. For example, an organization may have selected one or more ECM solutions using the GUI 200 as described in FIG. 2, whereby the organization can then transmit planning input comprising an indication of one or more selected ECM solutions through the network, such as to the ECM provider. In other words, the planning input is generated by the organization by selecting from the set of ECM solutions presented to it. In an embodiment, the ECM data transmitted at 104 comprises a GUI configured to cause planning input to be transmitted through the network, such that planning input is received at 106. A GUI configured to cause planning input to be transmitted to the ECM provider is described below in FIG. 2.

In an example where the associated ECM solution has a fixed price, the planning input may be a direct purchase order from the customer to implement the ECM solution. In this case, a confirmation step may be provided to clarify that, by proceeding, the organization is agreeing to purchase the ECM solution. In an example where the associated ECM solution has none or only a general cost estimate provided in the ECM solution detailed information, the planning input is a request to the ECM provider to reply with a customized cost and/or time quote for providing the ECM solution.

At 108, planning data is accessed from data storage. The planning data accessed at 108 is associated with the one or more ECM solutions indicated as selected by the indication, and comprises information pertaining to the one or more ECM solutions. Planning data associated with an ECM solution comprises at least one of a cost, resource requirement, or time period associated with implementing the ECM solution. Planning data may also comprise tasks or events associated with implementing an ECM solution as well as costs, resource requirements, or time periods for the respective tasks or events.

At 110, implementation information is computed. The implementation information is based at least in part upon the planning data, and comprises at least one of a cost, resource requirement, or time period for implementing the one or more ECM solutions. The implementation information may be computed by a processor. The cost may be a generalized cost estimate, a customized cost estimate, or a definite cost for a purchase.

At 112, the implementation information is transmitted through the network. For example, the implementation information may be transmitted to a computing device, such as a computing device of the organization. In other embodiments, the implementation information may not need to be transmitted, such as for example, in embodiments where the implementation information is computed by the computing device of the organization.

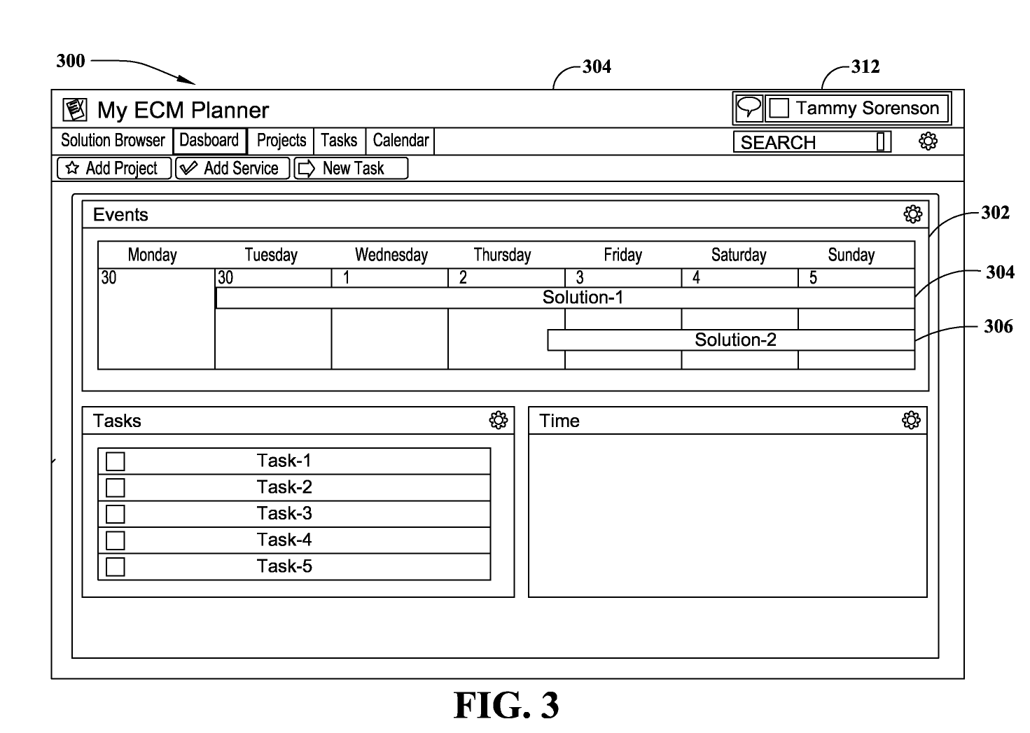

The implementation information comprises a GUI configured such that the display is caused to display at least a portion of the implementation information. For example, the implementation information may be configured to cause a GUI (such as the GUI 300 of FIG. 3) for displaying at least a portion of the implementation information to be displayed on a computing device, such as, for example, the computing device of the organization.

Referring now to FIG. 2, an exemplary graphical user interface (GUI) 200 that the ECM data is configured to cause to be displayed is illustrated. The GUI 200 comprises a plurality of icons 202A-F that represent a set of ECM solutions, and each icon is representative of a specific ECM solution. For example, an icon 202A comprises information about the respective ECM solution, such as a title and a brief description. An organization may select one or more icons 202A-F to indicate a selection of the one or more ECM solutions associated with the icons 202A-F.

In some embodiments, the icons 202A-F comprise a graphical indication that the organization has already implemented the ECM solution associated with the respective icon. For example, an icon may be a different color if the associated ECM solution has been implemented by the organization or an additional graphic such as a check or “x” may be displayed as part of the icon.

In some embodiments, the icon 202A may be interacted with, such as by clicking with a point and click device, and responsive to the interaction, may display ECM solution detailed information. In some embodiments, the icon 202A is a card that displays a “flipping” animation when selected by a point and click device. On the back of the flipping card is the ECM solution detailed information.

In an example, the ECM solution detailed information includes a general definition of the solution, a general cost estimate for implementation of a solution, and an estimate on the time to implement a solution. The general nature of the estimates is for informational and research purposes. For certain ECM solutions, a fixed price and/or time to implement the solution may be provided as part of the ECM solution detailed information. In an example, this option is available for solutions that are simple and/or have been routinely implemented by the provider. In some embodiments, the ECM solution detailed information comprises detailed statistics about the respective ECM solution.

In some embodiments, the cost for an ECM solution represents a fixed cost for which the one or more ECM solutions may be purchased. In some embodiments, the resource requirement for an ECM solution may be selected from: a requirement for a number of worker hours of an implementing organization, a requirement for a number of information technology workers from the implementing organization, a requirement for a number of data-entry technology workers from the implementing organization; a requirement for a number of management personnel from the implementing organization, a requirement for designated computer hardware, or combinations thereof

In an example, the ECM solution detailed information also includes ECM collaborative information that is generated by users of the tool. The ECM collaborative information includes: ECM solution feedback information received from a user of the ECM tool, which may or may not be revised by the ECM provider.

The ECM collaborative information feature allows a decision-maker to not only review what other ECM solutions are available in the industry, but to actually review feedback from other users of the tool that have implemented or are in the process of implementing the solution. The decision-maker could also contact those organizations that are willing to be contacted from the contact information provided in the ECM solution detailed information. The contact information may be in the form of an e-mail address, a phone number, a fax number, or a mail-box or instant message application supported by the ECM tool itself.

In an example, privacy data or information stored in data storage is associated with the ECM collaborative information and defines whether the user that generated the feedback has allowed the feedback and/or contact data to be shared globally or with only certain organizations.

For example, the privacy information may include a list of certain organizations or organization identifiers that are not authorized to receive the feedback and/or contact information. Alternatively, the privacy information may include a list of only organizations that are authorized to receive the feedback and/or contact information. In an example, the privacy data is associated with all collaborative information received from a user and is stored as ECM organization information. In another example, the privacy data is associated with the particular collaborative information received from the user on a particular ECM solution.

The exemplary GUI 200 comprises a Drag-to-Add Field 204. When an icon 202A is dragged into the Drag-to-Add Field 204, such as by clicking-and-dragging with a point and click device, the respective ECM solution is indicated as selected. The Drag-to-Add field facilitates the selection of a plurality of ECM solutions for storage and further review. In some embodiments, one or more ECM solutions may be selected without the dragging interaction or without use of the Drag-to-Add Field 204. For example, selection can be made by clicking or double-clicking with a point and click device, or other selections methods. The selections may show up as an icon or title in the Drag-to-Add field 204.

In an example, the GUI 200 includes information that is not transmitted at the same time or displayed at the same time. In an example, the steps of transmitting and/or receiving may not be a single transmission but may be a series of transmissions transmitted at intervals in response to electronic requests, such as a click on a display field, received from a user.

When ECM solutions are indicated as selected, such as by dragging at least one of the icons 202A-F into the Drag-to-Add Field 204, planning input comprising the indications is transmitted through the network to the ECM provider, as described with respect to step 106 above. Implementation information based at least in part upon the planning input and the planning data is then computed and transmitted through the network to the computing device of the organization. For example, in an embodiment, when one or more ECM solutions are indicated in the Drag-to-Add Field 204, implementation information becomes available in the GUI illustrated in FIG. 3 as described below.

Referring now to FIG. 3, an exemplary GUI 300 that the implementation information may be configured to cause to be displayed is illustrated. The GUI 300 comprises information associated with the one or more ECM solutions. For example, the GUI 300 comprises a calendar field 302, wherein graphical indicators such as the graphical indicators 304 and 306 can graphically indicate the time period to implement ECM solutions such as Solution-1 and Solution-2, respectively. In other words, the calendar field 302 comprises a plurality of day or date fields, and a time period for implementing a solution would be indicated by the day or date fields covered by a graphical indicator.

The GUI 300 comprises additional information or features relating to the one or more ECM solutions, as is described in further detail below. For example, the GUI 300 may comprise an instant message, e-mail, or other communication link 312 to the ECM provider's customer service department. In an example, the display data may present an option for electronically submitting feedback for a set of the ECM solutions provided in the template. This may be customized based on an organization identifier to only allow a user to provide feedback on ECM solutions they that have implemented and/or are implementing, as described below.

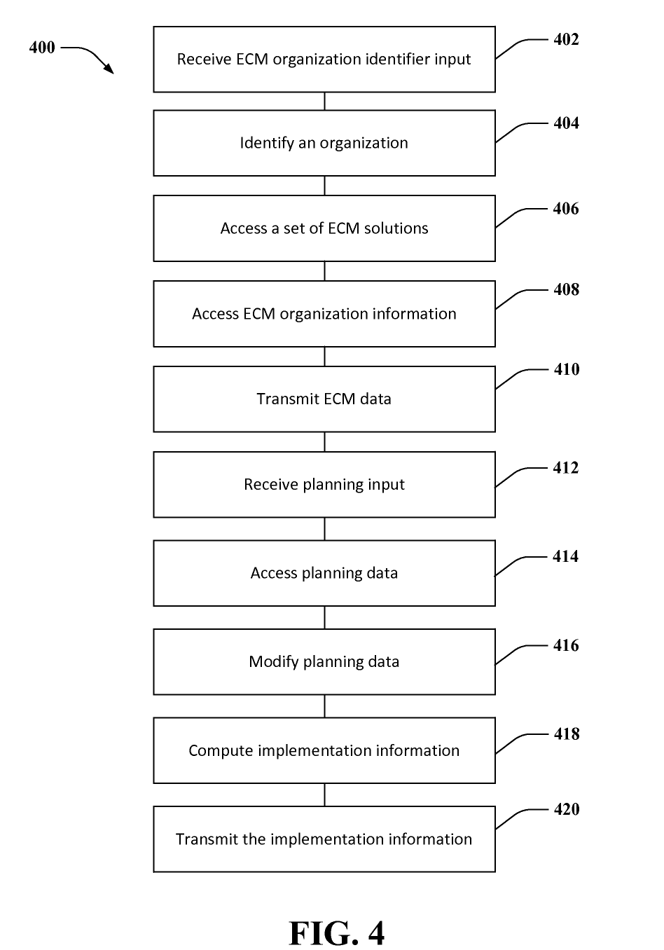

Referring now to FIG. 4, another exemplary methodology 400 that facilitates providing ECM solution information is illustrated. In this embodiment, the methodology 400 allows for customization of certain aspects of the information being provided based on known factors about the organization requesting information.

The data storage also stores information comprising a set of industry-group-associated templates that comprise a set of ECM solutions selected to be pertinent to the industry groups associated with the templates along with ECM solution detailed information associated with the ECM solutions. In other words, the set of ECM solutions accessed at 104 may be a set of ECM solutions pertinent to a particular industry group. The pertinent industry group may be identified based at least in part upon ECM organization identifier input.

The methodology 400 starts at 402 as ECM organization identifier input is received. In some embodiments, an organization may request ECM solution information, whereby the organization transmits a request for ECM solution information that comprises an ECM identifier input. In other embodiments, communication between a computing device of the organization and a computing device of the ECM provider, such as the server, may be indicative of an identity of an organization, whereby an ECM organization identifier input may be received through recognition of such an indication.

At 404, the organization is identified. In some embodiments, an organization information database comprises identities of organizations respectively associated with ECM organizational identification input. The organization is identified based at least in part on the ECM organization information input, such as, for example, through an examination of the organization information database.

In some embodiments, identifying an organization further comprises authentication, whereby transmission through the network are authenticated and/or encrypted, such as by using encryption keys, cookies, or the like.

At 406, a set of ECM solutions is accessed. In some embodiments, a particular set of ECM solutions is accessed based at least in part upon the identified organization. At 408 ECM organization information associated with the identified organization is accessed.

In an example, the ECM organization information includes: information about the size of the identified organization (as determined by revenue, industry ranking, or number of employees), industry operations of the organization, privacy data for solutions implemented by the organization, server or database infrastructure information, hardware and software information, information on an organization's IT personnel, a number of ECM provider's onsite personnel already at the organization, or support center history. The ECM organization information also includes ECM implementation information, which identifies ECM solutions offered by the provider that have already been implemented and/or are in the process of being implemented by the identified organization, including version and license information for such ECM solutions. In an example, the ECM implementation information is the only ECM organization information.

At 410, ECM data comprising the set of ECM solutions is transmitted through the network. At 412, planning input is received through the network, and at 414 planning data is accessed.

At 416, the planning data is modified based at least in part upon the ECM organization information. For example, a cost, resource requirement, or time period associated with an ECM solution may be modified based at least in part upon the ECM organization, such as, for example, information that an organization has a threshold amount of IT personnel that may facilitate implementation of the ECM solution. In another example, previously implemented ECM solutions may facilitate the implementation of an ECM solution. For example, the cost, resource requirement, or time period associated with an ECM solution may be modified based, at least in part, upon the prior implementation of another ECM solution. In a non-limiting example included for the purposes of illustration, having previously implemented an electronic document management system, such as an electronic project assignment system solution, may facilitate the implementation of an ECM solution and reduce the time and cost of the solution.

At 418, implementation information is computed, at 420 the implementation information is transmitted through the network.

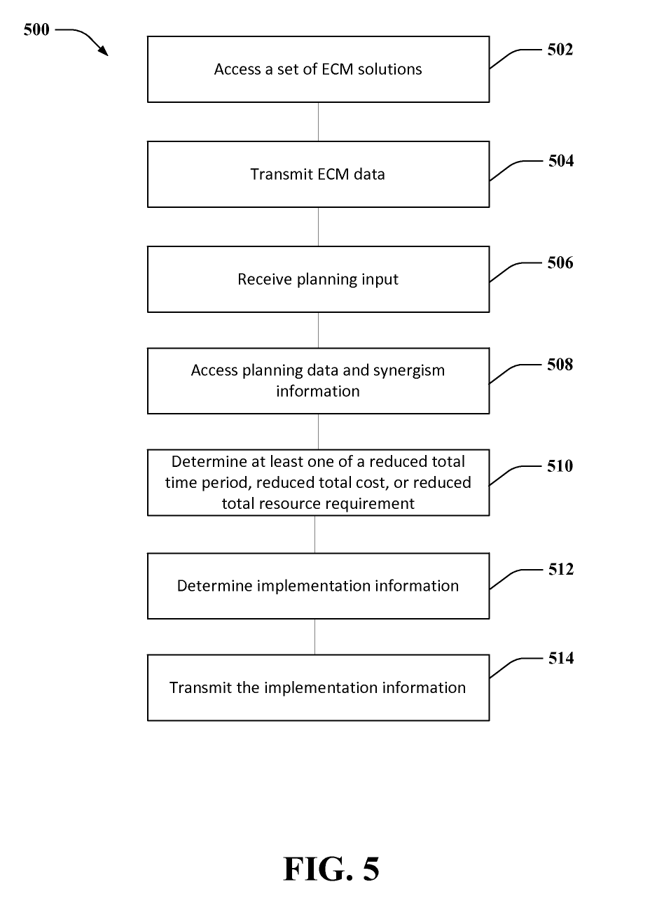

Referring now to FIG. 5, yet another exemplary methodology 500 that facilitates providing ECM solution information is illustrated. The methodology 500 begins at 502 as a set of ECM solutions is accessed. At 504, ECM data is transmitted through the network. At 506 planning input comprising an indication of two or more selected ECM solutions is received. At 508 planning data and synergism information is accessed. The synergism information may be stored on the data storage or another data storage, and comprises information relating to benefits for implementing the two or more ECM solutions in combination.

At 510, at least one of a reduced total time period, reduced total cost, or reduced total resource requirement associated with implementation of the two or more indicated ECM solutions is determined. The respective reduction is in comparison to a sum of time periods, costs, or a resource requirement respectively associated with the implementation of each of the two or more indicated ECM solutions alone, and is based at least in part upon the synergism information. In a non-limiting example included for the purposes of illustration, implementing an electronic document management system solution may require similar resources, steps, or other materials as would implementing an electronic project assignment system solution, and thus the total cost, resource requirement, time period, or combinations thereof may be less than the sum of implementing such solutions individually.

At 512, implementation information is determined based at least in part on the planning data and the synergism information and includes at least one of: the reduced total time period, the reduced total resource requirement, or the reduced total cost.

At 514, the implementation information is transmitted through the network.

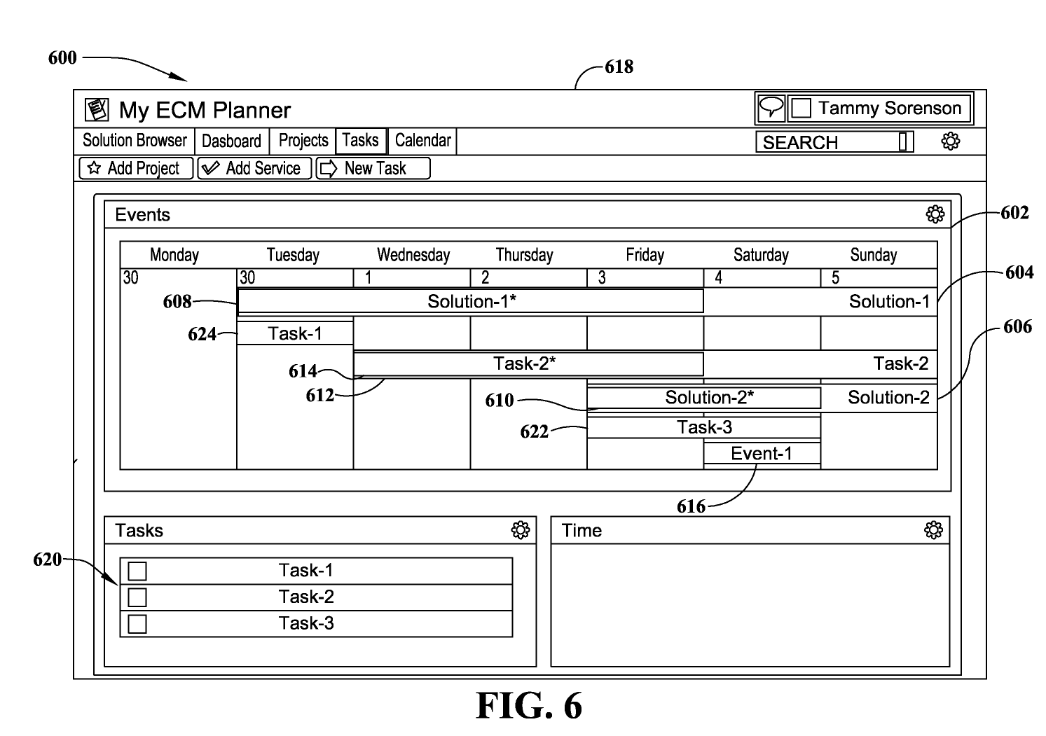

Referring now to FIG. 6, an exemplary GUI 600 that the implementation information may be configured to cause to be displayed is illustrated. The GUI 600 comprises a calendar field 602, wherein graphical indicators 604 and 606 graphically indicate the time period to implement ECM solutions, Solution-1 and Solution-2, respectively. The calendar field 602 of the exemplary GUI 600 further comprises graphical indicators 608 and 610 that are representative of the time period for implementing Solution-1* and Solution-2* respectively, which are representative of reduced total time periods for Solution-1 and Solution-2 and represent adjustments based on the synergism information.

The calendar field 602 further comprises graphical indicators representative of the time period for certain tasks or events related to the implementation of an ECM solution, such as graphical indicator 612 which is representative of a task, Task-2, associated with implementing Solution-1 and graphical indicator 616 which is representative of an event, Event-1, associated with implementing Solution-2. In the calendar field 602 each graphical indicator is a bar that extends across the relevant time periods represented on the calendar field 602. An ECM solution, such as Solution-1 604 may have multiple tasks associated with it, such as Task-2 614 and Task-1 624, and an ECM solution may also be associated with both tasks and events, such as Solution-2 606 being associated with Task-3 622 and Event-1 616. Additional tasks or events may be added to a solution, and tasks or events may be removed from a solution.

Tasks may relate to actions to be undertaken, such as, for example, gathering information such as budget or cost information, scheduling actions such as meetings or briefings, identifying personnel to help lead the ECM project, purchase necessary software, upgrade server hardware, or have the legal department approve a contract. In an embodiment, tasks can be akin to items on a “to-do” list. They can be predefined, or created by the end-user ad-hoc. Tasks are the items that support the ECM project usually indirectly, but are required for the success of the project, and allow the customer to identify operational or tactical items that need to be completed. Tasks are tied to the completion of a solution and are typically required to be completed before the solution is implemented.

Events may relate to occurrences, implementation steps, benchmark points, or deadlines associated with implementing an ECM solution. In an embodiment, events may be described as “milestones.” For example, there may be a “discovery phase” that occurs at the start of an ECM implementation. This could include in-person meetings, phone calls, or online collaboration. Each of these may be considered a milestone type of event. In an embodiment, there is a “Go-Live” deadline that marks when the project is fully implemented and tested. Events may be pre-defined based upon the proven methodologies of implementing specific ECM solutions. They may also be created and altered as an implementation of the ECM solution progresses.

Events may be tied to the completion of a solution, but may be separate although still related to the completion of the solution. For example, some events may not be “tied” to the main ECM solution implementation. In an embodiment, on the calendar field 602, an event may be free to move around the project timeline without affecting the other events or tasks. Therefore, such events may not need to be completed in a particular order, or at all, for the success of the project. Furthermore, events may not necessarily be directly related to the implementation. For example, there may be an event for reviewing phase 2 recommendations, where a meeting is scheduled for looking at future solutions based upon the expected outcome of the current ECM implementation.

The calendar field 602 further comprises graphical indicators representative of a reduced time period for a task or an event, such as a graphical indicator 614. The reduced time period for a task or event is a time period for the respective task or event modified based at least in part upon the synergism information.

In other embodiments, the GUI 600 further comprises user interactive buttons to add or remove ECM solutions. For example, the GUI 600 may comprise a button that, when clicked, returns to the GUI 200 described above.

The GUI 600 further comprises a tasks list 620. The tasks list 620 comprises a list of tasks associated with the one or more ECM solutions. In an embodiment, the tasks list 620 is a user interactive field. For example, a user may select a task in the tasks list 620 to edit information associated with the task, add additional tasks, or remove tasks. Selecting a task in the tasks list 620 may also highlight it in the calendar field 602.

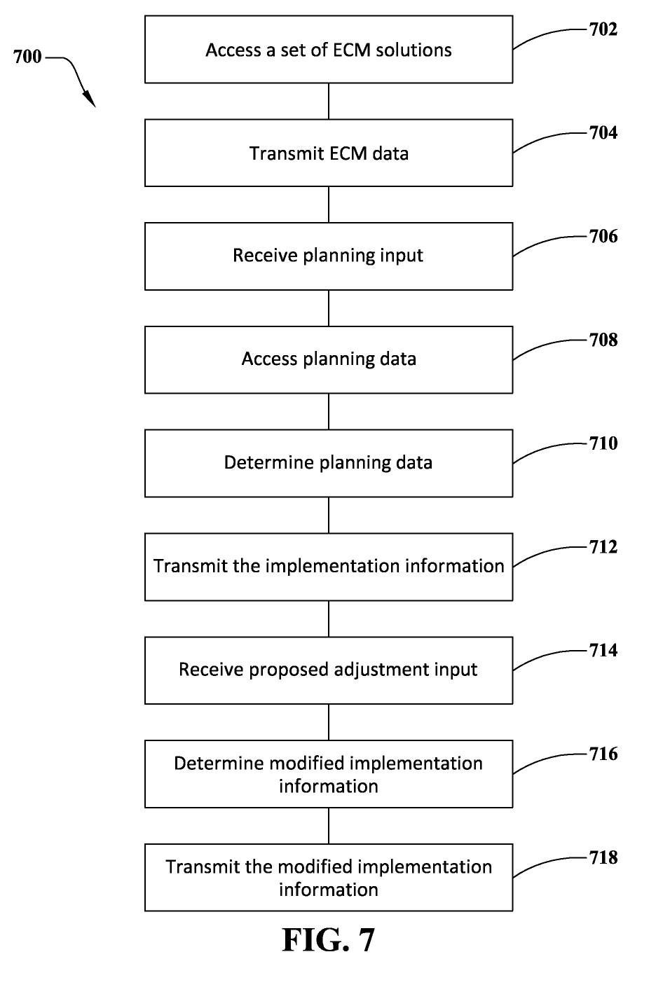

Referring now to FIG. 7, yet another exemplary methodology 700 that facilitates providing ECM solution information is illustrated. This methodology 700 provides an opportunity for an organization and the ECM provider to correspond with each other and negotiate the resource, cost, and time period requirements of the implementation of the set of selected ECM solutions.

The methodology 700 starts with a set of ECM solution being accessed at 702. At 704, ECM data is transmitted through the network, and at 706 planning input, generated by the organization, is received through the network. At 708, planning data is accessed, and, at 710, implementation information is computed.

At 712, the implementation information is transmitted through the network. The implementation information comprises a GUI configured to accept proposed adjustment input. For example, returning to FIG. 6, the GUI 600 comprises a user interactive field 618, which is configured to accept planning adjustment input. In some embodiments, the calendar field 602 is a user-interactive calendar field. In some embodiments, graphical indicators such as the graphical indicators 604 and 606 may be manipulated, such as for example, moved to indicate a time period with different start and end dates, or resized so as to indicate reduced or increased time period.

In some embodiments, the location, start and end dates, or time periods of solutions, tasks, and events may be manipulated. For example, graphical indicator 606 may be clicked-and-dragged and repositioned above graphical indicator 604. Vertical orientation may be used to indicate priority of ECM solutions. For example, a user of an organization may wish to indicate that Solution-1 604 is higher priority than Solution-2 606, and so has positioned it above Solution-2 606. Unique orientations of multiple solutions may be stored on a per-user basis, such that when different users view the implementation information, the ECM solutions are oriented to that user's preferences.

When a graphical indicator of an ECM solution is moved to a new vertical location, graphical indicators of tasks or events associated with the ECM solution are moved as well. For example, when a user repositions Solution-2 606 above Solution-1 604, the graphical indicators for Task-3 622 and Event-1 616 are relocated to be above Solution-1 604 as well. In other words, events or tasks relating to an ECM solution, such as graphical indicator 616 may automatically be moved when the graphical indicator 604 of the associated ECM solution is moved, so as to maintain the relative location of tasks and events with the respective graphical indicator of their associated ECM solution. In an embodiment, a repositioning of a solution above another solution will shift the start dates of tasks and events to have priority in time and resources over lower priority solutions.

In an embodiment, the location of start and end dates, or time periods of graphical indicators for tasks, events, and/or solutions may be stored in ECM organization information associated with the organization, so that such locations can be automatically restored when the organization makes subsequent requests for ECM solution information.

In some embodiments, the time period for an ECM solution, task, or event may be broken up into two or more time periods, such as from example by dividing a respective graphical indicator into two or more subdivided graphical indicators. For example, instead having a time period extend through a weekend, a holiday, or an expected busy time, the time period could be broken up to allow the organization's employees that would be involved in the implementation to be free during that time period.

In some embodiments, when the time period for an ECM solution is modified, the time periods for some or all of the tasks or events associated with the ECM solution are also modified based at least in part upon the modification to the time period of the ECM solution.

In some embodiments, other information relating to an ECM solution may be modified using the GUI 600. In a non-limiting example included for the purposes of illustration, right-clicking on a graphical indicator, such as the graphical indicator 604 or graphical indicator 614 may open up a user-interactive field configured to accept modifications in the implementation information associated with the ECM solution, task, or event. In an embodiment, this field may also be accessed by selecting the task or event from a task list 620 or a similar event list user interactive field. In an embodiment, the resource requirements for a particular task or event or for the entire implementation solution can be adjusted in this user-interactive field. For example, the default resource requirements may indicate that two IT personnel from the organization must participate in the implementation of the ECM solution. However, the organization may only have one IT employee available. The organization can thus adjust this resource requirement from two to one.

The GUI comprised by the implementation information is configured to cause proposed adjustment information to be transmitted through the network. For example, if a user of the organization computing device modifies the time period of Solution-1 in the GUI 600, such manipulation causes proposed adjustment information to be transmitted to the ECM provider. In some embodiments, proposed adjustment information may not be transmitted until the user indicated that the user's modifications are complete, such as by selecting a confirmation button. At 714, proposed adjustment information is received through the network, wherein the proposed adjustment information comprises any modifications to the implementation information.

Returning to the methodology 700 of FIG. 7, at 716, modified implementation information is determined. The modified implementation information is based at least in part upon the proposed adjustment information, and comprises at least one of a modified cost, a modified resource requirement, or a modified time period for implementing one or more ECM solutions, which are based at least in part upon the respective costs, resource requirements, or time periods of the one or more ECM solutions as modified by the proposed adjustment information.

Upon receiving the proposed adjustment input, the ECM provider may accept the proposed adjustment “as is” and determine modified implementation information accounting for the changes in the proposed adjustment input. For example, computation of the modified implementation information may include automatically adjusting a time length of a solution implementation, task, or event, based on a change to a resource requirement, or vice versa.

In an embodiment, the ECM provider manually modifies the implementation information based at least in part upon the proposed adjustment input. In other words, the ECM provider may incorporate provider proposed adjustment input into the modified implementation information, so as to continue a “conversation” between the organization and the ECM provider. Here, the ECM provider may make further modifications in response to modifications included in the proposed adjustment information or modified implementation information, and may compute responsive modification information incorporating such modifications. For example, if the proposed adjustment information includes a reduction in the IT personnel resource requirement, the responsive modification may include an increase in the total time and/or an increase in the cost associated with the ECM solution.

If the ECM provider accepts the proposed adjustment information “as is”, then an electronic confirmation of such may be sent to the organization and displayed on the GUI, and/or the ECM provider may contact the organization by telephone, facsimile, or e-mail. In some embodiments, the proposed adjustment input may be to purchase one or more ECM solutions, as modified, at a fixed cost, wherein the proposed adjustment input is a purchase order. For example, an ECM solution may have various prices associated with various implementation time periods, and the proposed adjustment input may comprise a selection of a specific time period for a specific fixed price.

Because in some instances the time period, cost, and resource requirements conveyed in the methodology 700 will be estimates, rather than fixed value, it is contemplated that before the modified implementation information is transmitted, before the proposed adjustment information is accepted by the ECM provider, the ECM provider may have a telephone conversation, internet chat, or in-person dialog with the organization to solidify the estimates.

In summary, the step of determining modified implementation information may comprise manual modifications by the ECM provider, automatic modifications by the ECM provider, as well as further communication between the ECM provider and the organization.

At 718, the modified implementation information is transmitted through the network. For example, the modified implementation information may be transmitted to a computing device, such as a computing device of the organization.

The steps of receiving proposed adjustment information 714, determining modified implementation information 716, and transmitting modified implementation information 718 may be iterated, for example, until the ECM provider accepts the modifications comprised by an iteration's respective proposed adjustment information, or until the organization accepts the modifications made by the ECM provider. When neither the organization nor the ECM provider objects to the modified implementation information, the methodology 700 ends.

In addition, several functional block diagrams of exemplary systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

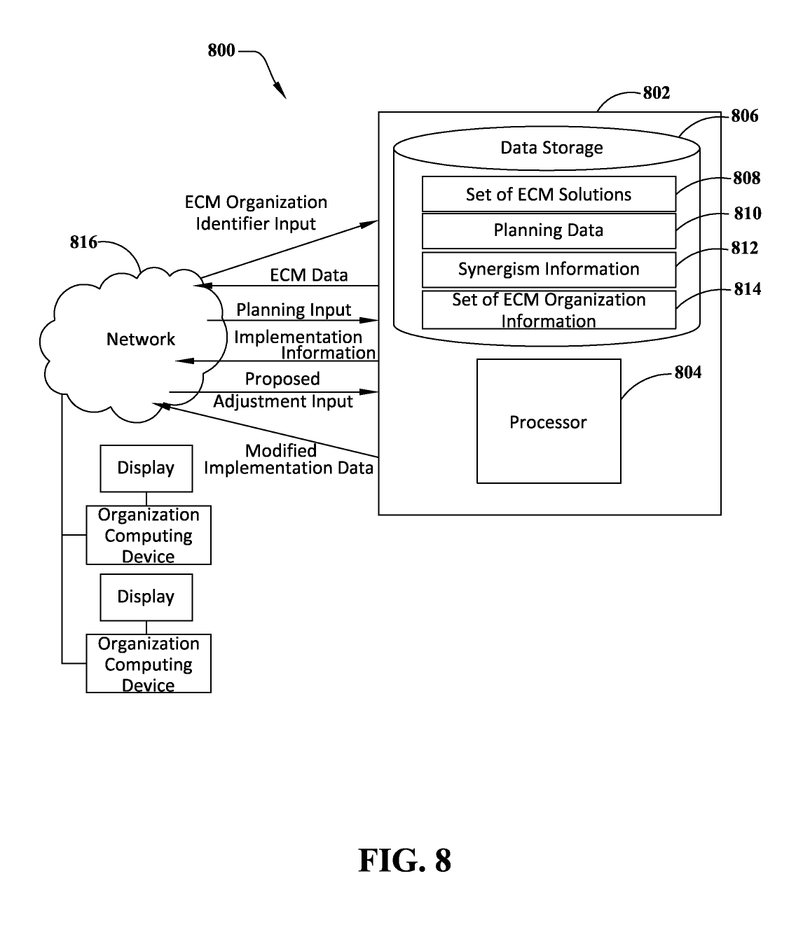

Referring now to FIG. 8, an exemplary system 800 that facilitates providing ECM solution information is illustrated. The system 800 comprises a data storage 806 that comprises a set of ECM solutions 808, planning data 810 associated with one or more of the ECM solutions from the set of ECM solutions, synergism information 812 that comprises information about benefits to implementing two or more ECM solutions from the set of ECM solutions in combination, and ECM organization information 814 comprising, for each of a plurality of organizations, at least one of historical information of previously implemented ECM solutions, a number of and/or types of personnel, or other information associated with the organization. Although depicted as separate entities stored in a single data storage 806, it should be understood that the entities 808, 810, 812, 814 may be combined into one or more combined entities, and may be stored across one or more data storages or sets of data storages.

The system further comprises a server 802 and a processor 804 configured to execute instructions that cause the server 802 to perform the following acts: 1) Receive ECM organization identifier input through a network 816. 2) Identify an organization. 3) Access a set of ECM solutions. 4) Transmit ECM data through the network 816. 3) Receive planning input through the network 816. 4) Compute implementation information. 5) Transmit implementation information through the network 816. 6) Receive proposed adjustment input through the network 816. 7) Determine modified implementation information. 8) Transmit modified implementation information through the network 816.

As embodied in FIG. 8, the server 802 comprises the data storage 806 and the processor 804, although it should be understood that in other embodiments, the data storage 806 and/or the processor 804 may be comprised by another computing device or other computing devices. The term processor should be construed broadly as it is not meant to be limited to a single processor if multiple processors could perform the same function.

The server 802 is configured to transmit and receive encrypted data and/or facilitate encryption of data on other computing devices such as devices in communication with the server 802 through the network 816, such as by communicating encrypted data and utilizing key, session information, and/or cookies.

In an example, the system 800 is in communication with a computing device through the network 816, wherein the computing device comprises a display configured to display GUIs that transmissions of the server may cause to be displayed, as described above.

As embodied in FIG. 8, the network 816 may be a LAN, WAN, the Internet, a virtual network, or other communications between computing devices or components of a computing device.

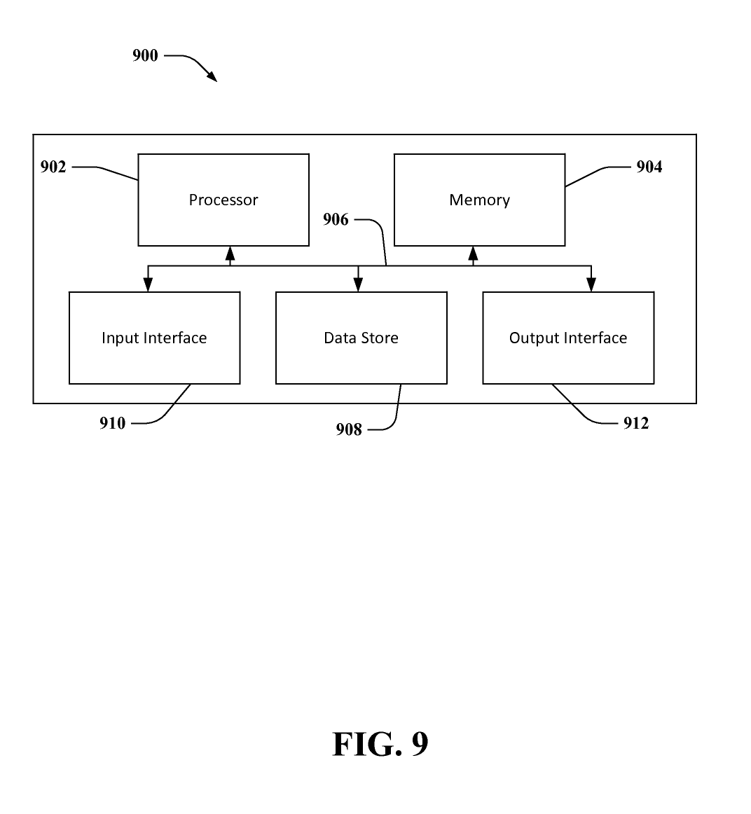

Referring now to FIG. 9, an illustration of an exemplary computing device 900 that can be used in accordance with the systems and methodologies disclosed herein is illustrated. The computing device can be implemented as part of the method or system by the ECM provider to input various ECM-related information, maintain or modify the ECM tool, or communicate with the organization users of the ECM tool. The computing device 900 can also be implemented as part of the method or system by the organization user in viewing the display data as the graphical user interface. In an example, a computing device 900 can include at least the data storage 806 and processor 804 components of FIG. 8. In an example, FIG. 9 is an example of a server 802 of FIG. 8.

The computing device 900 includes data storage 908 that is accessible by the processor 902 by way of the system bus 906. The data storage 908 may include executable instructions to operate the processor 902 and other components. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

As used herein, the terms “tool” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and BLU-RAY (BD), where disks usually reproduce data magnetically and discs usually reproduce data optically with lasers. Further, in an example, a propagated signal is not included within the scope of computer-readable storage media or display data. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

It is claimed:

1. A method executed by a processor of a computing device, the method comprising the following acts:
accessing, from a data storage of the computing device, a set of enterprise content management (ECM) solutions;
transmitting ECM data comprising the set of ECM solutions through a network;
receiving planning input through the network, the planning input comprising an indication of one or more ECM solutions selected from amongst the set of ECM solutions;
responsive to the receiving of the planning input, accessing, from the data storage, planning data associated with the one or more indicated ECM solutions;
determining implementation information based at least in part upon the planning data, wherein the implementation information comprises at least one of a time period for implementing the one or more indicated ECM solutions, or a resource requirement for implementing the one of more indicated ECM solutions; and
transmitting the implementation information through the network.

2. The method of claim 1, wherein the implementation information comprises a calendar graphically showing the time period for implementing the one or more indicated ECM solutions.

3. The method of claim 1, wherein the resource requirement is selected from: a requirement for a number of worker hours of an implementing organization, a requirement for a number of information technology workers from the implementing organization, a requirement for a number of data-entry technology workers from the implementing organization; a requirement for a number of management personnel from the implementing organization, a requirement for designated computer hardware, or combinations thereof.

4. The method of claim 1, wherein the implementation information comprises a user-interactive field configured to receive proposed adjustment input associated with at least one of the time period requirement or resource requirement, the method further comprising receiving the proposed adjustment input.

5. The method of claim 4, further comprising, responsive to receiving the proposed adjustment input, determining modified implementation information comprising at least one of a modified time period, a modified resource requirement, or a modified cost requirement, and causing the modified implementation information to be transmitted through the network.

6. The method of claim 4, wherein the user interactive field comprises a calendar field configured to receive proposed adjustment input entered by manipulating a graphical indicator representative of a time period over certain dates on the calendar.

7. The method of claim 6, wherein the calendar field is a user interactive field configured to accept input to move the graphical indicator to begin at a different date, to break up the graphical indicator into two or more time periods, or to change the duration of the graphical indicator.

8. The method of claim 7, wherein the calendar field comprises an indicator of a task time period or an event time period for a respective task or event to be completed as part of the implementation of the one or more indicated ECM solutions, and further comprising modifying the task time period or event time period when the graphical indicator is moved.

9. The method of claim 8, further comprising modifying at least one of the cost or resource requirement when the graphical indicator is moved.

10. The method of claim 1, wherein more than one ECM solution is indicated, and the determining of the implementation information includes determining a synergistic reduction in at least one of a total time period, a total cost, or a total resource requirement based on synergism information associated with the more than one indicated ECM solution.

11. The method of claim 1, wherein the planning data further comprises a cost requirement.

12. The method of claim 1, wherein the ECM data further comprises:
a plurality of icons representative of the ECM solutions in the set of ECM solutions; and
a drag-to-add field, wherein each icon in the plurality of icons is configured to be dragged to the drag-to-add field.

13. A method for providing enterprise content management (ECM) solution information executed by the processor of a computing device, the method comprising the following acts:
receiving ECM organization identifier input through a network;
identifying an organization based at least in part upon the ECM organization identifier input, thereby determining an identified organization;
accessing, from a data storage of the computing device, a set of ECM solutions and ECM organization information associated with the identified organization;
transmitting ECM data comprising the set of ECM solutions through the network;
receiving planning input through the network, the planning input comprising an indication of one or more ECM solutions selected from amongst the set of ECM solutions;
responsive to receiving the planning input, accessing, from the data storage, planning data associated with the one or more indicated ECM solutions;
modifying the planning data based at least in part upon the ECM organization information;
determining implementation information based at least in part upon the planning data and the ECM organization information, wherein the implementation information comprises at least one of a time period for implementing the one or more indicated ECM solutions, a resource requirement for implementing the one or more indicated ECM solutions, or a cost for implementing the one or more indicated enterprise content management solutions; and
transmitting the implementation information through the network.

14. The method of claim 13, wherein the ECM organization information comprises at least one of information on previously implemented ECM solutions or information on organization IT personnel.

15. The method of claim 13, wherein the ECM organization information comprises: information about the size of the identified organization (as determined by revenue, industry ranking, or number of employees), industry operations of the organization, privacy data for solutions implemented by the organization, server or database infrastructure information, hardware and software information, information on an organization's IT personnel, a number of ECM provider's onsite personnel already at the organization, ECM solutions that have already been implemented or are in the process of being implemented, version and license information for such ECM solutions, or support center history.

16. The method of claim 13, wherein the cost is a fixed amount and the indicated ECM solution can be purchased for the cost.

17. A method for providing enterprise content management (ECM) solution information executed by the processor of a computing device, the method comprising the following acts:
accessing, from a data storage of the computing device, a set of ECM solutions;
transmitting ECM data comprising the set of ECM solutions through a network;
receiving planning input through the network, the planning input comprising an indication of two or more ECM solutions selected from amongst the set of ECM solutions;
responsive to the receiving planning input, accessing, from the data storage, planning data and synergism information associated with the two or more indicated ECM solutions;
determining, based at least in part upon the synergism information and planning data, at least one of a reduced total time period, reduced total cost, or reduced total resource requirement associated with implementation of the two or more indicated ECM solutions, the respective reduction being in comparison to a sum of respective time periods, costs, or resource requirements associated with the implementation of each of the two or more indicated ECM solutions separately;
determining implementation information based at least in part upon the planning data and synergism information, wherein the implementation information comprises at least one of: the reduced total time period, the reduced total resource requirement, or the reduced total cost; and
transmitting the implementation information through the network.

18. The method of claim 17, wherein the implementation information comprises a calendar field, the calendar field including a graphical indicator of the reduced total time period for implementing the two or more indicated ECM solutions.

19. The method of claim 17, wherein the calendar field comprises an indicator of a task time period or an event time period for a respective task or event to be completed as part of the implementation of the two or more indicated solutions.

20. The method of claim 19, wherein the indicator of the task time period or event time period is a bar that stretches across the task or event time period on the calendar, the task or event time period being within the total time period.

21. The method of claim 19, wherein the task time period or event time period is modified by the synergism information.

22. A system for providing enterprise content management (ECM) solution information comprising:
a data storage device comprising: a set of ECM solutions, planning data associated with two or more of the ECM solutions in the set of ECM solutions, synergism information, and a set of ECM organization information;
a processor; and
a server comprising instructions that, when executed by the processor, are configured to do the following acts:
receive an ECM organization identifier input through a network;
determine an identified organization based at least in part upon the ECM organization identifier input
cause ECM data comprising the set of ECM solutions to be transmitted through the network;
receive planning input through the network, the planning input comprising an indication of two or more ECM solutions selected from amongst the set of ECM solutions,
modify the planning data associated with the two or more ECM solutions indicated by the planning input based at least in part upon ECM organization information associated with the identified organization from amongst the set of ECM organization information;
determine, based at least in part upon the synergism information and the modified planning data, at least one of a reduced total time period, reduced total cost, or reduced total resource requirement associated with implementation of the two or more indicated ECM solutions, the respective reduction being in comparison to a sum of respective time periods, costs, or resource requirements associated with the implementation of each of the two or more indicated ECM solutions;
determine implementation information based at least in part upon the modified planning data and the synergism information, wherein the implementation information comprises at least one of: the reduced total time period, the reduced total resource requirement, or the reduced total cost, wherein the implementation information further comprises a user interactive field configured to receive proposed adjustment input;
cause the implementation information to be transmitted through the network;
receive proposed adjustment input associated with at least one of the reduced total time period, the reduced total resource requirement, or the reduced total cost;
determine modified implementation information based at least in part upon the proposed adjustment input, the modified implementation information comprising at least one of a modified total time period, a modified total resource requirement, or a modified total cost requirement; and
cause the modified implementation information to be transmitted through the network.
